(19) United States
(12) Patent Application Publication
(10) Pub. No.: US 2016/0123299 A1
(43) Pub. Date: May 5, 2016

(54) Dual rotor wind turbine generator set

(71) Applicant: Tangshan TOYODA Technology Co., Ltd, Tangshan (CN)

(72) Inventor: Xin Zhao, Tangshan (CN)

(73) Assignee: Tangshan TOYODA Technology Co., Ltd

(21) Appl. No.: 14/530,814

(22) Filed: Nov. 2, 2014

(51) Int. Cl. F03D 3/00; H02K 7/18; F03D 9/00; F03D 3/02; F03D 3/06

(52) U.S. Cl. CPC F03D 3/005; F03D 3/02; F03D 3/061; F03D 9/002; H02K 7/183

(57) ABSTRACT

A dual rotor wind turbine generator set includes an upper vertical wind wheel unit, a lower vertical wind wheel unit, a cruciform framework, and a generator located within the cruciform framework and between the upper vertical wind wheel unit and the lower vertical wind wheel unit. One of three upper blades are installed to an upper vertical shaft perpendicular to the ground. A plurality of upper semi-elliptical or semi-conical turbulence enhancing components are located at an upper leading edge of one of the upper blades. Two upper winglets are respectively installed at two ends of one of the upper blades. One of the upper blades is cut from a position at 32% upper leading edge along an upper chord thereof, as a starting point, to an upper trailing edge thereof. The wind turbine generator set has no direction and no noise and has high power generation efficiency and wind resistance.

### BACKGROUND OF THE PRESENT INVENTION

1. Field of Invention

The present invention relates to the wind power technical field, and more particularly to a vertical shaft wind turbine generator set which starts power generation via breeze.

2. Description of Related Arts

Most of the existing wind turbine generator use the horizontal shaft structure, which changes the wind wheel direction via the empennage, so that the front of the wind wheel directly upwind rotates to drive the permanent magnet generator to generate electricity. Accordingly, the wind wheel has large noise, low wind resistance, and high starting wind speed. The wind speed needs more than 2 m/s to start the wind wheel. Therefore, the generation efficiency of the generator is low.

### SUMMARY OF THE PRESENT INVENTION

An object of the present invention is to provide a dual rotor wind turbine generator set which can breeze start, has no noise and high power generation efficiency.

Accordingly, in order to accomplish the above object, the present invention provides a dual rotor wind turbine generator set, comprises an upper vertical wind wheel unit, a lower vertical wind wheel unit, a cruciform framework, and a generator located within the cruciform framework and between the upper vertical wind wheel unit and the lower vertical wind wheel unit,

wherein the upper vertical wind wheel unit reversely rotates around the lower vertical wind wheel unit;

wherein the upper vertical wind wheel unit comprises three upper blades, an upper vertical shaft, two upper stands and an upper connecting rod, wherein one of the three upper blades are installed to an upper vertical shaft perpendicular to the ground via the two upper stands and the upper connecting rod, and the two upper stands evenly spaced from top to bottom and paralleled to the ground are located between one of the three upper blades and the upper vertical shaft;

wherein the lower vertical wind wheel unit comprises three lower blades, a structure of the lower vertical wind wheel unit is similar to that of the upper vertical wind wheel unit;

wherein every two adjacent upper blades define an angle of 120 degrees, every two adjacent lower blades define an angle of 120 degrees, one of the three upper blades and one of the three lower blades closed thereto form an angle of 60 degrees.

The present invention has beneficial effects as follows. The upper vertical wind wheel unit reversely rotates around the lower vertical wind wheel unit. A plurality of semi-elliptical or semi-conical turbulence enhancing components are located at a leading edge of every blade. An angle of 15-30 degrees is formed between one of the winglets and a corresponding blade. The lift coefficient is 1.1-1.5. A blade is cut from a position at 32% leading edge along a chord thereof, as a starting point, to a trailing edge thereof, so that the wind with low Reynolds coefficient within a range of 25000˜2500000 in any direction is applied to the upper and lower vertical wind wheel units. When the upper and lower wind wheel units drive the dual rotor generator to rotate, the wind lift and resistance can be simultaneously used, the present invention is reversely rotated to increase the rotation speed, and the power generation efficiency. The present invention can be started by 1 m/s breeze, and has no noise, no direction and strong wind resistance.

These and other objectives, features, and advantages of the present invention will become apparent from the following detailed description, the accompanying drawings, and the appended claims.

### BRIEF DESCRIPTION OF THE DRAWINGS

FIG. 1 is an exterior oblique view of a dual rotor wind turbine generator set according to a preferred embodiment of the present invention.

FIG. 2 is an exterior oblique view of a wind wheel unit according to the above preferred embodiment of the present invention.

FIG. 3 is a schematic view of the turbulence enhancing component according to the above preferred embodiment of the present invention.

FIG. 4 is a top view of the wind wheel unit according to the above preferred embodiment of the present invention.

FIG. 5 is a structural view of the blade of the wind wheel unit according to the above preferred embodiment of the present invention.

FIG. 6 shows the connecting relationship between the blades, the connecting rod and the stands according to the above preferred embodiment of the present invention.

FIG. 7 is an air pressure distribution map of the blade.

FIG. 8 is a rotation schematic view of the blade of the wind wheel unit according to the above preferred embodiment of the present invention.

FIG. 9 is a schematic view of a charging system according to the above preferred embodiment of the present invention.

### DETAILED DESCRIPTION OF THE PREFERRED EMBODIMENT

The present invention is further explained in detail with the accompanying drawings.

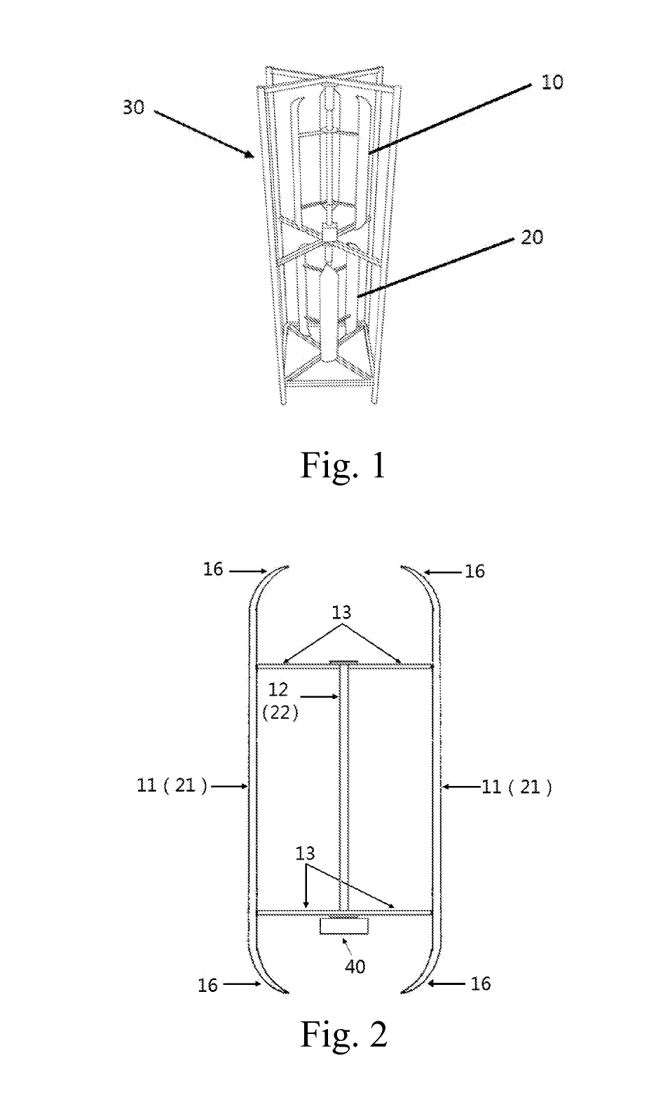

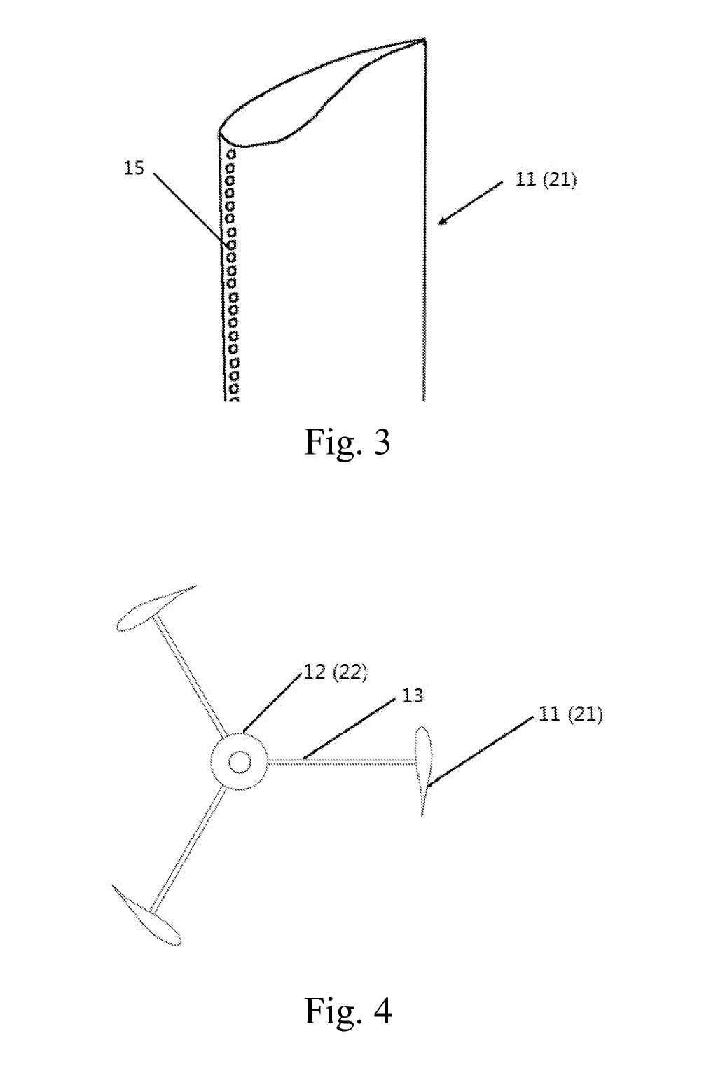

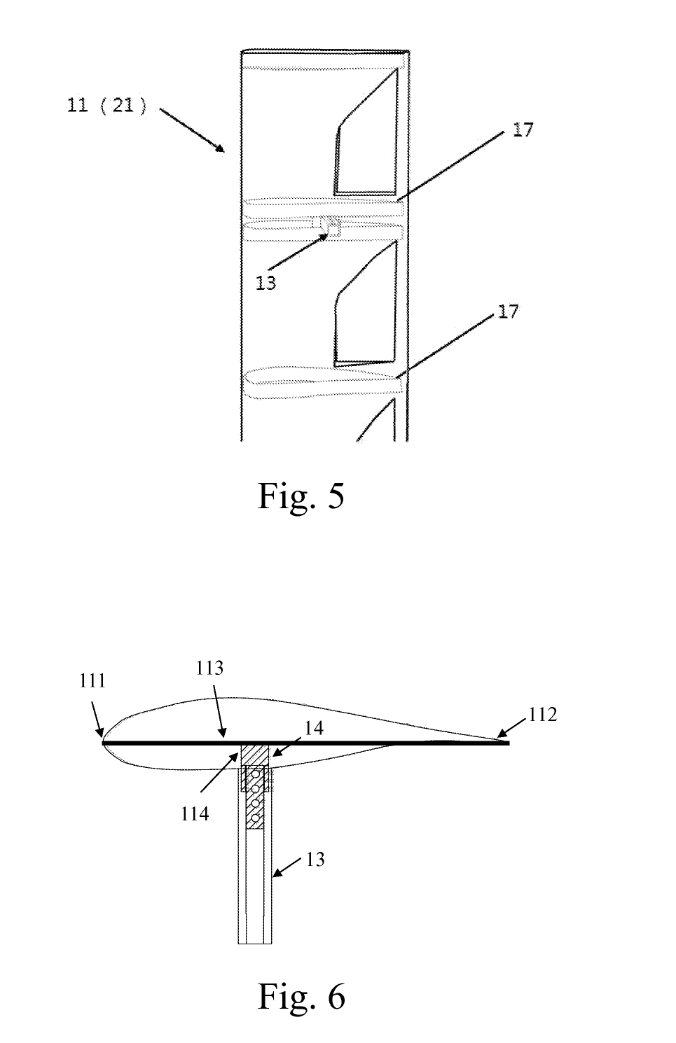

Referring to FIG. 1 of the drawings, a dual rotor wind turbine generator set according to a preferred embodiment of the present invention is illustrated, wherein the dual rotor wind turbine generator set comprises an upper vertical wind wheel unit 10, a lower vertical wind wheel unit 20, a cruciform framework 30, and a disc dual rotor permanent magnet brushless generator 40 located within the cruciform framework 30 and between the upper vertical wind wheel unit 10 and the lower vertical wind wheel unit 20, characterized in that: the upper vertical wind wheel unit 10 reversely rotates around the lower vertical wind wheel unit 20, the upper vertical wind wheel unit 10 comprises three upper blades 11, the lower vertical wind wheel unit 20 comprises three lower blades 21, every two adjacent upper blades define an angle of 120 degrees, every two adjacent lower blades define an angle of 120 degrees, one of the three upper blades 11 and one of the three lower blades 21 closed thereto form an angle of 60 degrees. One of the three upper blades 11 are installed to an upper vertical shaft 12 perpendicular to the ground of the upper vertical wind wheel unit 10 via two upper stands 13 and an upper connecting rod 14. A plurality of upper semi-elliptical or semi-conical turbulence enhancing components 15 are located at an upper leading edge 111 of one of the upper blades 11. As shown in FIG. 2, two upper winglets 16 are respectively installed at two ends of one of the upper blades 11, and an angle of 15-30 degrees is formed between one of the upper winglets 16 and a corresponding upper blade 11. One of the three upper blades 11 has an aircraft aliform shape with a lift coefficient of 1.1-1.5. As shown in FIG. 5, according to the wing aerodynamic principle, one of the three upper blades 11 is cut from a position at 32% upper leading edge 111 along an upper chord 113 of one of the three upper blades 11, as a starting point, to an upper trailing edge 112 thereof, so that the wind with low Reynolds coefficient within a range of 25000˜2500000 in any direction is applied to the upper vertical wind wheel unit 10. As shown in FIGS. 2 and 4, the two upper stands 13 evenly spaced from top to bottom and paralleled to the ground are located between one of the three upper blades 11 and the upper vertical shaft 12 to form the upper vertical wind wheel unit 10. One of the three upper blades 11 is formed by crimping an aluminum alloy or resin sheet material to an upper skeleton 17. As shown in FIG. 6, the upper chord 113 of one of the three upper aliform blades 11 and one of the two upper stands 13 define an angle of 1-6 degrees 114. The skeleton 17 is implanted into one of the three upper blades 11. Referring to FIGS. 5 and 6, an upper connecting rod 14 located within the upper skeleton 17 is connected with the upper vertical shaft 12 via the two upper stands 13. It is worth to mention that the structure of the lower vertical wind wheel unit 20 is similar to that of the upper vertical wind wheel unit 10 mentioned above.

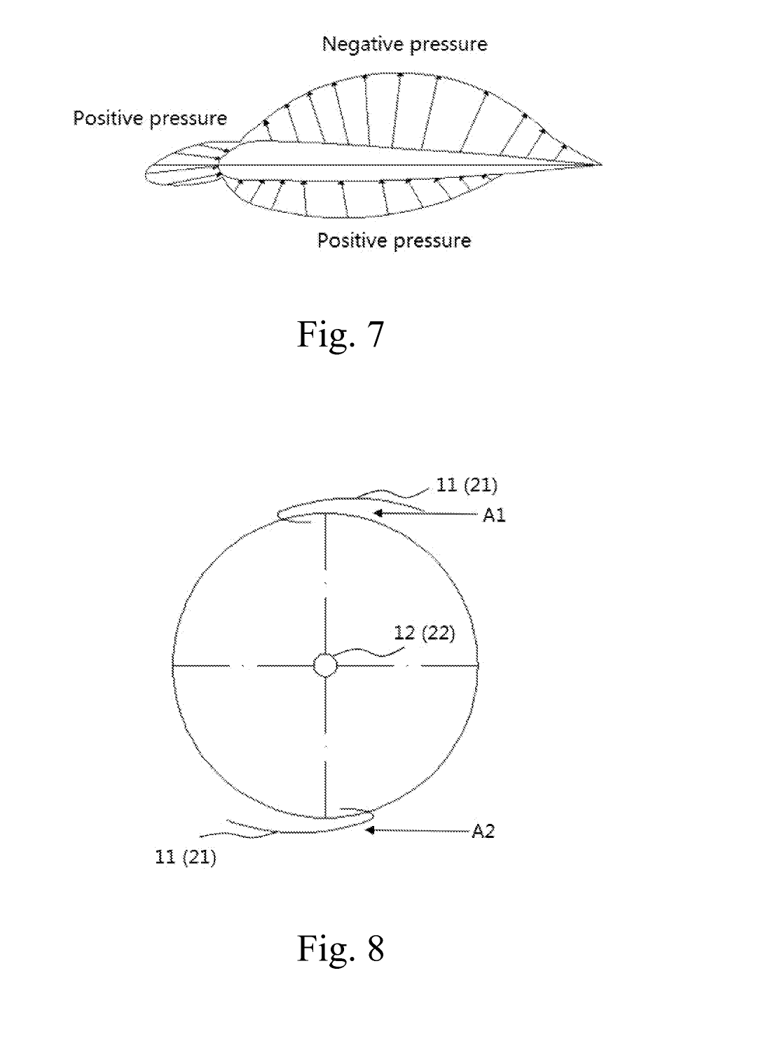

FIG. 7 is an air pressure distribution map of one of the three upper blades 11. A lower anterior air pressure of one of the three upper blades 11 is higher than an exterior air pressure thereof, a lower posterior air pressure is basically equal to the exterior air pressure thereof, and an upper anterior air pressure is lower than the exterior air pressure thereof due to the accelerated flow air at the aliform upper anterior of one of the three upper blades 11. Therefore, there is no effect on the aerodynamic characteristics of one of the three upper blades 11 by cutting the lower posterior thereof. Referring to FIG. 8, at the low wind area with a tip-speed-ratio lower than 1, a lower posterior cutting part of one of the three upper blades 11 uses the wind resistance (along the A1 arrow direction) for generating a torque to rotate the upper vertical wind wheel unit 10; at the high wind area with a tip-speed-ratio higher than 1, one of the three upper blades 11 uses the wind (along the A2 arrow direction) for generating a lifting force to rotate the upper vertical wind wheel unit 10, that is to say, the upper vertical wind wheel unit 10 with low Reynolds coefficient and high lift coefficient has high power generation efficiency at various wind areas. After adding the upper winglets 16, it is convenient for one of the three upper blades 11 to remove the turbulence effects at the upper and lower ends thereof. After adding the upper turbulence enhancing components 15 at the upper leading edge 111 of one of the three upper blades 11, the lift is improved so that the wind wheel efficiency is increased to 60%. One of the three upper blades 11 is made of aluminum alloy or resin or other lightweight materials, so that the whole weight of the upper vertical wind wheel unit 10 is decreased to reduce the load produced by the centrifugal force. Similarly, the above-mentioned principle is also adapted to the lower vertical wind wheel unit 20.

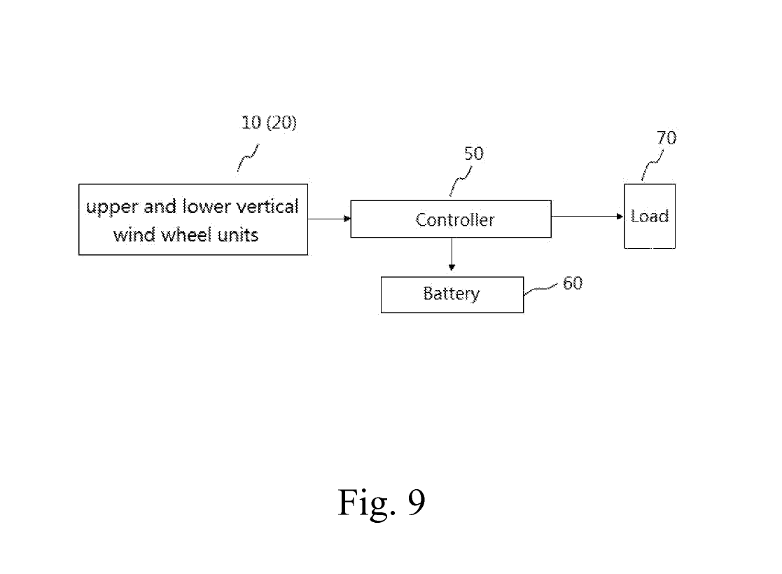

As shown in FIG. 9, the turbine generator of the present invention is formed by connecting the rare earth permanent magnet coreless generator 40, a controller 50, a battery 60, a load 70 with each other in turn. The upper vertical wind wheel unit 10 and the lower vertical wind wheel unit 20 drive the rare earth permanent magnet coreless generator 40 for generating electricity, and then send the electricity to the controller 50, and then the controller 50 sends the electricity to the battery 60 by rectifying, increasing and decreasing the pressure for storing the electricity energy to drive the load 70.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A dual rotor wind turbine generator set, comprising an upper vertical wind wheel unit, a lower vertical wind wheel unit, a cruciform framework, and a generator located within the cruciform framework and between the upper vertical wind wheel unit and the lower vertical wind wheel unit,
wherein the upper vertical wind wheel unit reversely rotates around the lower vertical wind wheel unit;
wherein the upper vertical wind wheel unit comprises three upper blades, an upper vertical shaft, two upper stands and an upper connecting rod, wherein one of the three upper blades are installed to an upper vertical shaft perpendicular to the ground via the two upper stands and the upper connecting rod, and the two upper stands evenly spaced from top to bottom and paralleled to the ground are located between one of the three upper blades and the upper vertical shaft;
wherein the lower vertical wind wheel unit comprises three lower blades, a structure of the lower vertical wind wheel unit is similar to that of the upper vertical wind wheel unit;
wherein every two adjacent upper blades define an angle of 120 degrees, every two adjacent lower blades define an angle of 120 degrees, one of the three upper blades and one of the three lower blades closed thereto form an angle of 60 degrees.

2. The dual rotor wind turbine generator set, as recited in claim 1, wherein the generator is a disc dual rotor permanent magnet brushless generator.

3. The dual rotor wind turbine generator set, as recited in claim 1, wherein a plurality of semi-elliptical or semi-conical turbulence enhancing components are located at a leading edge of one of the blades.

4. The dual rotor wind turbine generator set, as recited in claim 2, wherein a plurality of semi-elliptical or semi-conical turbulence enhancing components are located at a leading edge of one of the blades.

5. The dual rotor wind turbine generator set, as recited in claim 1, wherein two winglets are respectively installed at two ends of one of the blades, and an angle of 15-30 degrees is formed between one of the winglets and a corresponding blade.

6. The dual rotor wind turbine generator set, as recited in claim 2, wherein two winglets are respectively installed at two ends of one of the blades, and an angle of 15-30 degrees is formed between one of the winglets and a corresponding blade.

7. The dual rotor wind turbine generator set, as recited in claim 3, wherein two winglets are respectively installed at two ends of one of the blades, and an angle of 15-30 degrees is formed between one of the winglets and a corresponding blade.

8. The dual rotor wind turbine generator set, as recited in claim 4, wherein two winglets are respectively installed at two ends of one of the blades, and an angle of 15-30 degrees is formed between one of the winglets and a corresponding blade.

9. The dual rotor wind turbine generator set, as recited in claim 5, wherein one of the blades is cut from a position at 32% leading edge along a chord of one of the blades, as a starting point, to a trailing edge thereof, so that a wind with low Reynolds coefficient within a range of 25000˜2500000 in any direction is applied to the upper vertical wind wheel unit and the lower vertical wind wheel unit.

10. The dual rotor wind turbine generator set, as recited in claim 6, wherein one of the blades is cut from a position at 32% leading edge along a chord of one of the blades, as a starting point, to a trailing edge thereof, so that a wind with low Reynolds coefficient within a range of 25000˜2500000 in any direction is applied to the upper vertical wind wheel unit and the lower vertical wind wheel unit.

11. The dual rotor wind turbine generator set, as recited in claim 7, wherein one of the blades is cut from a position at 32% leading edge along a chord of one of the blades, as a starting point, to a trailing edge thereof, so that a wind with low Reynolds coefficient within a range of 25000˜2500000 in any direction is applied to the upper vertical wind wheel unit and the lower vertical wind wheel unit.

12. The dual rotor wind turbine generator set, as recited in claim 8, wherein one of the blades is cut from a position at 32% leading edge along a chord of one of the blades, as a starting point, to a trailing edge thereof, so that a wind with low Reynolds coefficient within a range of 25000˜2500000 in any direction is applied to the upper vertical wind wheel unit and the lower vertical wind wheel unit.

13. The dual rotor wind turbine generator set, as recited in claim 7, wherein a skeleton is implanted into one of the blades, the connecting rod is located within the skeleton and connected with the vertical shaft via the two stands.

14. The dual rotor wind turbine generator set, as recited in claim 8, wherein a skeleton is implanted into one of the blades, the connecting rod is located within the skeleton and connected with the vertical shaft via the two stands.

15. The dual rotor wind turbine generator set, as recited in claim 11, wherein a skeleton is implanted into one of the blades, the connecting rod is located within the skeleton and connected with the vertical shaft via the two stands.

16. The dual rotor wind turbine generator set, as recited in claim 12, wherein a skeleton is implanted into one of the blades, the connecting rod is located within the skeleton and connected with the vertical shaft via the two stands.

17. The dual rotor wind turbine generator set, as recited in claim 11, the chord of one of the three upper blades and one of the two upper stands define an angle of 1-6 degrees.

18. The dual rotor wind turbine generator set, as recited in claim 12, the chord of one of the three upper blades and one of the two upper stands define an angle of 1-6 degrees.

19. The dual rotor wind turbine generator set, as recited in claim 15, the chord of one of the three upper blades and one of the two upper stands define an angle of 1-6 degrees.

20. The dual rotor wind turbine generator set, as recited in claim 16, the chord of one of the three upper blades and one of the two upper stands define an angle of 1-6 degrees.
